(19) United States
(12) Patent Application Publication
(10) Pub. No.: US 2026/0264234 A1
(43) Pub. Date: Sep. 10, 2026

(54) ARTIFICIAL INTELLIGENCE BASED ROBOTIC MANIPULATION

(71) Applicant: Dexterity, Inc., Redwood City, CA (US)

(72) Inventors: Zhouwen Sun, San Mateo, CA (US); Shawn Wang, Mountain View, CA (US)

(21) Appl. No.: 19/557,981

(22) Filed: Mar. 5, 2026

Related U.S. Application Data
(60) Provisional application No. 63/768,049, filed on Mar. 6, 2025.

(51) Int. Cl. B25J 9/16

(52) U.S. Cl. CPC B25J 9/163; B25J 9/161; B25J 9/1633; B25J 9/1679

(57) ABSTRACT

Artificial intelligence based robotic manipulation is disclosed. In various embodiments, a set of observations associated with a context in which a robotic manipulator is operating and an objective the robotic manipulator is configured to be used to achieve are received via a communication interface. A vector representation of the observations is generated. One or more layers of transformer are applied to the vector to generate an output vector. The output vector is used to generate a set of robot control commands for the robotic manipulator, which are sent to the robotic manipulator. The robotic manipulator performs, in response to the set of robot control commands, one or more actions associated with achieving the objective.

### CROSS REFERENCE TO OTHER APPLICATIONS

This application claims priority to U.S. Provisional Patent Application No. 63/768,049 entitled ARTIFICIAL INTELLIGENCE BASED ROBOTIC MANIPULATION filed Mar. 6, 2025 which is incorporated herein by reference for all purposes.

### BACKGROUND OF THE INVENTION

In logistics settings, such as warehouses and distribution centers, robots have been used to manipulate items, e.g., by picking items from shelves, pallets, or other source locations and placing each item in a destination location, e.g., a box, pallet, truck, shipping container, or other receptacle.

When a robot moves through a free space that is well understood, e.g., the scene is static and/or it can be clearly perceived via computer vision or other sensors or configuration data has been provided to indicate the dimensions and layout of the space and fixed obstacles in the space, the robot can safely move quickly, typically holding itself relatively stiffly to ensure its component parts, e.g., joints and links comprising an articulated robotic arm, all move precisely through planned trajectories.

A technical challenge is presented when the robotic system is less certain of the environment. For example, the environment may be very dynamic, with humans and other workers moving in and out of proximity to the robot. In such circumstances, the robotic system may have to discover and/or continuously update its estimation of the environment. For example, touch (e.g., force feedback), computer vision, or a combination thereof may be used to perceive and explore the environment, such as to slide a box or other item into a tight space in box, truck, pallet, or other container. In this less certain mode, the robotic system may move more slowly and operate less stiffly, e.g., to avoid causing damage to an item in its grasp and/or to the robot itself, just as a person walking through a darkened room might slow down and greater readiness to adapt to obstacles encountered along the way.

### BRIEF DESCRIPTION OF THE DRAWINGS

Various embodiments of the invention are disclosed in the following detailed description and the accompanying drawings.

FIG. 1 is a diagram illustrating an embodiment of an artificial intelligence (AI) based robotic manipulation system.

FIG. 2 is a diagram illustrating an embodiment of an artificial intelligence (AI) based robotic control system.

FIG. 3 is a diagram illustrating an embodiment of a system and approach to train an artificial intelligence (AI) based robotic control system.

FIGS. 4A-4D illustrate examples of hindsight refined trajectories in an embodiment of an artificial intelligence (AI) based robotic manipulation system.

FIG. 5 is a flow diagram illustrating an embodiment of a process to plan a hindsight refined trajectory in an embodiment of an artificial intelligence (AI) based robotic manipulation system.

FIG. 6 is a flow diagram illustrating an embodiment of a process to augment a set of training data to train an artificial intelligence (AI) based robotic manipulation system.

FIG. 7 is a flow diagram illustrating an embodiment of a process to augment a set of training data to train an artificial intelligence (AI) based robotic manipulation system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to provide a robotic system that learns to manipulate items in a potentially dynamic and/or uncertain environment. In various embodiments, a robotic system as disclosed herein uses one or more of configuration data, computer vision, and touch (e.g., force feedback) to perceive and estimate a current state of the environment, plan and/or update a plan to pick an item from a source location A, move it through a planned trajectory to a destination location B, and place it at the destination, avoiding obstacles that may exist and/or arise. Upon detecting an unexpected condition, the system determines and attempts to implement a strategy to respond to the condition. For example, if an edge or corner of a box gets caught on an obstacle, e.g., by box on which the box is to be stacked or a sidewall of a truck or other container, the system may back up a bit, raise and/or rotate the box in its grasp, re-plan a trajectory from the current location to the destination, and attempt to complete the placement.

In some embodiments, machine learning techniques may be used by the system to learn, over time, which responsive strategies/maneuvers worked best in which circumstances. In various embodiments, one or more heuristics and/or generative artificial intelligence (AI) techniques may be used to determine and select a strategy to respond to a condition. If successful, the system may remember the conditions and the strategy and may learn to consider the strategy as an option if the same and/or similar conditions are encountered in the future.

In various embodiments, generative AI techniques may be used to estimate the state of the environment, including items to be manipulated and/or to plan trajectories to move items through the environment.

For example, in some embodiments, generative AI transformers may be used to efficiently and accurately model a workspace and generate trajectories to move items through the workspace to achieve an objective, such as to stack items onto a pallet or unload them from a truck or container.

In various embodiments, generative AI techniques are used to “predict” a trajectory a robot should follow next, for example to complete a placement. For example, the robot may be tasked to pick a box or other item from a source location and move it to a destination location, such as a location on a pallet or on a wall or other arrangement of boxes in a truck or other container. The robot may use computer vision or other resources to estimate a state of the workspace and may use vision-based control to determine a trajectory and move the item to the vicinity of the placement location. Once near the placement location, a generative AI based control system as disclosed herein may be used to determine (predict) the next trajectory the robot should implement to continue or complete the placement. For example, a generative AI-predicted trajectory may include a set of velocities (magnitude and direction in 3D space), each associated with a predicted future time. The input (prompt) may be a set of observations that may include context and/or objectives, such as the start, end, and current position of the item to be moved, i.e., the robot end effector, at a current time t, as well as at least certain forces and/or torques that may reflect whether and/or the extent to which the item is in contact with adjacent boxes and/or other obstacles in the space (e.g., the torques in the x and y directions and force in the z direction). In some embodiments, additional inputs may be provided, such as RGB (2D) or 3D image data, state estimation (e.g., appearance, stability, etc. of a stack), etc.

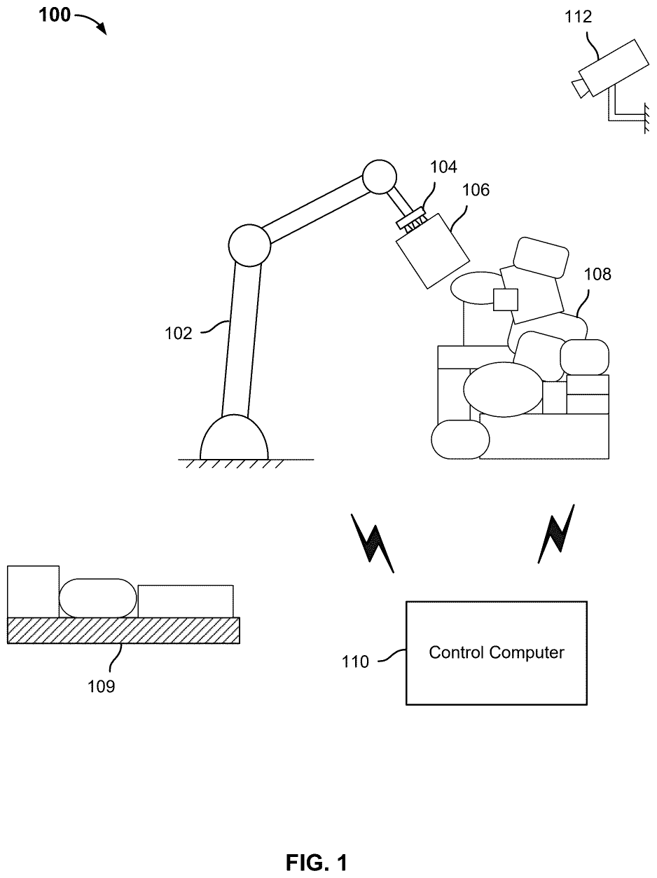

FIG. 1 is a diagram illustrating an embodiment of an artificial intelligence (AI) based robotic manipulation system. In the example shown, robotic system 100 includes a robotic arm 102 with a suction-type end effector 104 at its distal end. As shown, robotic arm 102 and end effector 104 have been used to grasp and lift box 106 from a pile of arbitrary items 108, including in this example boxes and other less regularly shaped items. In a logistics context, items 108 may include boxes, large and small articles not in packaging, articles in a polybag, such as a mailing bag, or other non-rigid packaging, etc. In the example shown, items from pile of arbitrary items 108 are being grasped, moved, and stacked singly on a pallet 109, e.g., for shipment, staging, storage, etc.

Robotic system 100 further includes a control computer 110 in wireless communication with robotic arm 102 and end effector 104, either directly or via a robot controller provided and configured to operate robotic arm 102 and end effector 104, e.g., in response to commands received from control computer 110. The robotic system 100 further includes a camera 112, e.g., a three-dimensional (3D) camera that provides two-dimensional image pixels (e.g., red, blue, green or RGB pixels) as well as a point cloud or other depth information. The latter information may be generated by measuring the “time of flight” (TOF) of an infrared or other signal emitted from the camera 112 and reflected back to a receiver comprising camera 112.

In various embodiments, image and depth information generated by one or more cameras, such as camera 112, is used by a control computer, such as computer 110, to generate and maintain a three-dimensional view of a workspace or at least a region of interest (ROI) within a workspace. The image data may be processed according to a Random Sample Consensus (RANSAC) or similar algorithm. The three-dimensional view may be used to control a robot, such as robotic arm 102 and end effector 104, to identify an object to be picked and placed, determine a strategy to grasp the object, and generate and implement a plan to move the object to a destination location and place the object at the destination location, e.g., in an orientation as indicated in the plan.

In various embodiments, artificial intelligence (AI) techniques disclosed herein may be used to control robotic arm 102 and/or end effector 104 of robotic system 100. For example, control computer 110 may be configured to use AI-based control techniques disclosed herein to plan a trajectory to grasp and move an item, such as item 106, from pile of arbitrary items 108 each to a corresponding placement on pallet 109.

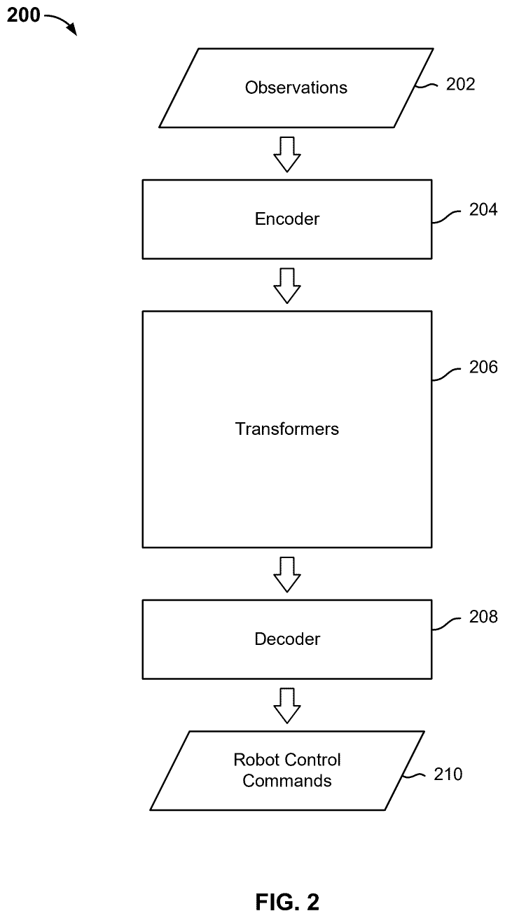

FIG. 2 is a diagram illustrating an embodiment of an artificial intelligence (AI) based robotic control system. In the example shown in FIG. 2, control system 200 receives inputs referred to as “observations” 202 (e.g., start, end, and current position, current torques and/or forces, workspace parameters, dynamically observed context such as a human working passing through the space) are provided to encoder 204, which uses the input to generate an input vector of values, which are in term provided to a set of transformers 206. The transformers 206 may comprise a multilevel neural network configured to apply transforming functions or other transformations to the input vector as received at that layer, e.g., the input vector at the first layer or intermediate results produced by a layer preceding the layer. The transformers produce an output that is mapped, by a “decoder” 208, to values having meaning in the required real-world domain, in this case robotic control commands 210. For example, a set of velocity vectors comprising a “predicted” trajectory may be provided.

In various embodiments, the observations 202 may be provided continuously (periodically) to the system 200 shown in FIG. 2, to iteratively update the trajectory based on the most recent observations 202.

To provide a generative AI-based robotic control system, such as the system 200 of FIG. 2, in various embodiments a combination and/or sequence of training phases may be implemented.

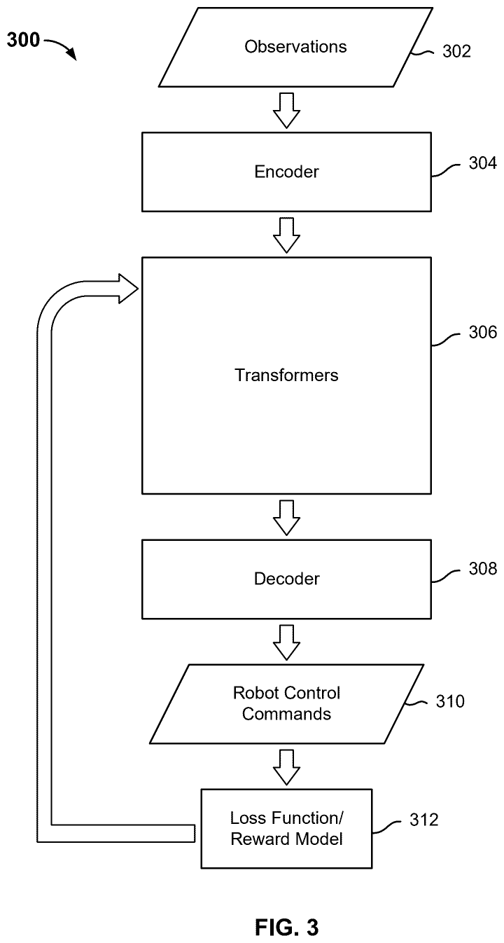

FIG. 3 is a diagram illustrating an embodiment of a system and approach to train an artificial intelligence (AI) based robotic control system. In the example shown, a set of observations 302 comprising a training data set, e.g., the inputs associated with a known good trajectory/plan, are provided as inputs to encoder 304, which generates a corresponding input vector to transformers 306, which generate an output processed by decoder 308 to produce a set of robot control commands 310. The robot control commands 310 are in turn processed via a “loss function”, “reward model”, a generative AI-based “judge”, or otherwise 312 to produce feedback that is used to adjust “weights” or other values that affect how the transformers 306 transform data. For example, in a first phase of training the system may adjust weights to minimize the difference between a trajectory predicted by the model based on a set of observations 302 and a corresponding known “good” trajectory. For example, in this first phase the system may be trained to mimic trajectories associated with one or more heuristics, such as to back up, move higher, and try again if the bottom edge of an item encounters resistance. In later training, the system 300 may use a reward function to assess the appropriateness or other goodness of a predicted trajectory. For example, the system may strive to minimize time, distance, compute resources, energy used, etc., and/or some weighted combination of two or more considerations.

In some embodiments, generative AI transformers are trained to generate trajectories at least part using diffusion model techniques. For example, the system 300 may be provided initially with a known good trajectory (or, alternatively, could pick a random or naïve, e.g., straight line, trajectory, to start). Iteratively, incrementally higher amounts of noise are added, and the system is tasked to reverse the noise. Eventually, the system learns to generate a trajectory from a starting location to a planned destination location, e.g., given the starting and ending locations and orientation of the item and a potentially noisy and/or incomplete view of the environment, for example.

In various embodiments, as an item is moved through a trajectory the system reassesses available information (e.g., vision, touch/force, and/or other sensor data) and regenerates/updates a trajectory from the current position to the destination.

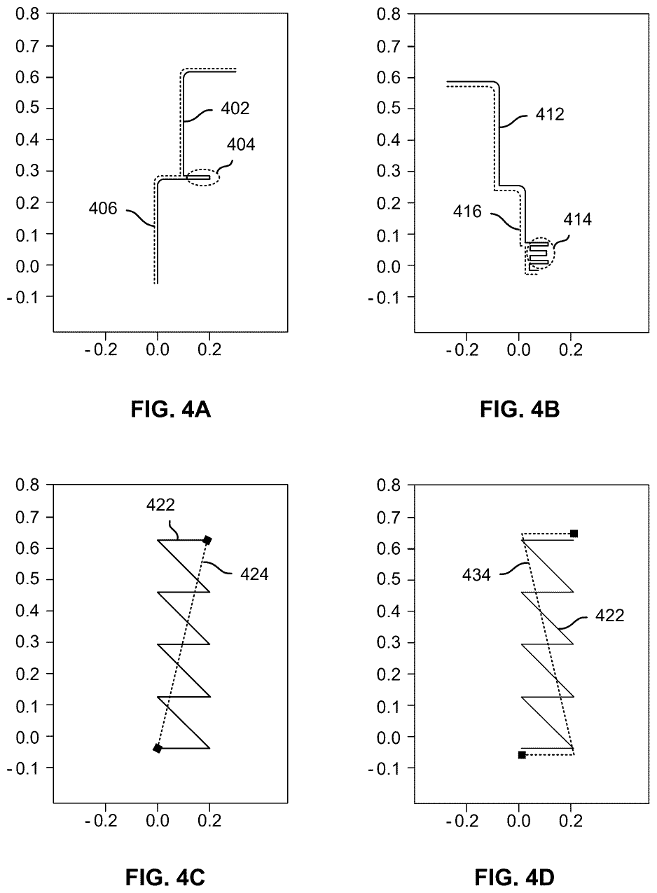

FIGS. 4A-4D illustrate examples of hindsight refined trajectories in an embodiment of an artificial intelligence (AI) based robotic manipulation system.

In various embodiments, a system as disclosed herein may generate, e.g., during a training phase, a trajectory that is not an optimal way to get from the starting location to the destination location. For example, the initial trajectory may may double back on itself, as shown in FIGS. 4A and 4B, or effectively zigzag through the intervening space, as shown in FIGS. 4C and 4D. In various embodiments, a trajectory generated as disclosed herein may be modified programmatically, such as by deleted points and/or segments that do not advance the item being manipulated towards the destination and are not necessary to avoid intervening obstacles, for example.

For example, in FIG. 4A, the initially generated trajectory 402 doubles back on itself, in the segments mark by ellipse 404, which in various embodiments may be pruned from the trajectory to provide a modified trajectory 406 that does not double back on itself. A similar example is shown in FIG. 4B, in which the initial trajectory 412 doubles back on itself multiple times in the segments within ellipse 414, which are shown to have been pruned to produce the modified trajectory 416, which does not double back.

FIGS. 4C and 4D illustrate alternative approaches to modifying a zigzag trajectory as mentioned above. In the example shown in FIG. 4C, the zigzag trajectory 422 has been modified to a straight line path 424, while in the example shown in FIG. 4D points between the first “zig” and last “zag” of trajectory 422 have been deleted to result in a trajectory 434 comprising a single “Z” shaped path.

In some embodiments, once a trajectory has been modified, as described above, e.g., by removing points/segments or portions thereof that effectively undo or reverse each other, the modified trajectory is added to the training set and another iteration of training, as described above, is performed.

In performing retraining, in various embodiments, one or more different approaches may be used. For example, a generative AI model may embody weights applied to inputs/features in successive stages or levels to generate a set of outputs based on a set of inputs. A “loss” function may be defined to measure how well the generated outputs match a desired output, and the loss may be used to adjust the weights. In some embodiments, retraining may be done from scratch, using the “old” weights from the previous iteration, or weights may be adjusted until the loss function is zero or halfway to zero, etc.

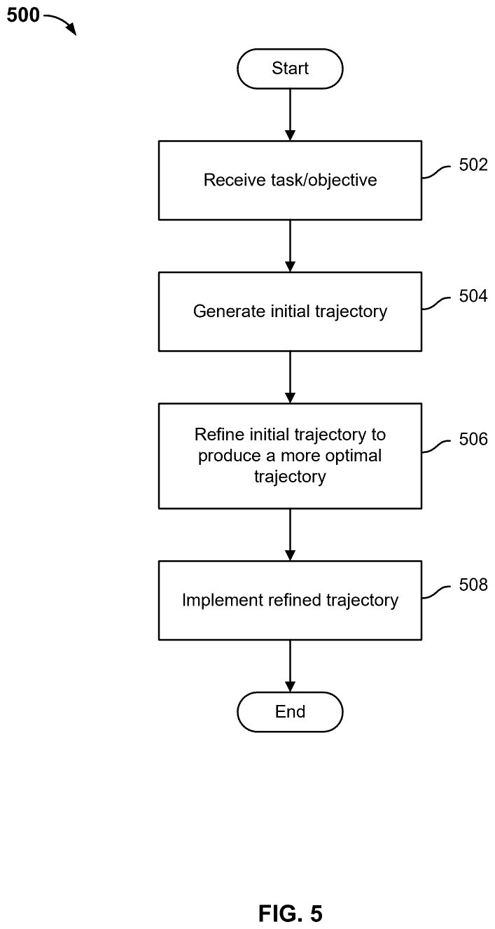

FIG. 5 is a flow diagram illustrating an embodiment of a process to plan a hindsight refined trajectory in an embodiment of an artificial intelligence (AI) based robotic manipulation system. In various embodiments, a control computer, such as control computer 110 of FIG. 1, may perform process 500, e.g., to produce hindsight refined trajectories as in the examples shown in FIGS. 4A-4D.

In the example shown in FIG. 5, a task or objective is received (or generated) at 502. For example, a task to pick items from an arbitrary pile of items and stack them on a pallet or in a container or other receptacle, as in the example shown in FIG. 1. At 504, an initial trajectory is generated. For example, the task or objective, initial position or other state information of the robot, parameters of the environment, estimated state of the pile, pallet, and/or environment based on sensor data, e.g., images from one or more cameras, etc. may be provided as observations to an AI-based robotic control system, e.g., as shown in FIG. 2, to generate an initial trajectory. At 506, the initial trajectory is refined, in hindsight, to produce a more optimal trajectory, as in the examples shown in FIGS. 4A-4D. For example, segments that do not advance an item towards its destination and which are determined at 506 not to be necessary to avoid a collision or other adverse consequence may be removed or simplified. At 508, the refined trajectory is implemented. For example, the refined trajectory may be provided to a robot control of the robot to implement.

In various embodiments, simulations may be performed, during training, to assess/score one or more models that are being developed via the training. For example, a simulation may be performed using a “fresh” set of boxes or other items the system has not seen previously, in a fresh scene. The simulation may be used to judge whether the model is a good model, e.g., based on whether it is successful in planning trajectories for all the items, how much time it takes to complete the manipulation (e.g., stacking boxes on a pallet), how much force is required, energy consumed, etc. For example, the goodness may be determined by comparing the trajectories generated by the model with corresponding heuristics and/or “gold” standard trajectories. In some embodiments, an actor critic model may have been trained to evaluate/judge the trajectories/plans generated by model.

In some embodiments, a system as disclosed herein may be trained to varying degrees. For example, a model may be trained to 50%, 80%, and 95% or 100%, producing a model for each of a plurality of epochs. Models from every epoch may be used to generate trajectories, and the results may be used to combinatorically select the input to the training data. The system may combinatorically select whether to fine-tune or to train from scratch or to freeze layers and then fine-tune, freeze layers and train from scratch. The system may do all of the above and just brute force search over all the options.

In some embodiments, in addition to training based on heuristics and/or modified heuristics, training and/or retraining may be performed, e.g., using modified versions of trajectories generated by the system during use.

In various embodiments, once a system hits a plateau, in terms of how much more it can improve itself via learning as described above, additional examples of good/useful trajectories maybe provided to effectively extend or add to the system's experience, i.e., what it has seen or known. For example, human supervised learning may be performed. A human expert may operate the robot, e.g., via teleoperation, to perform challenging tasks, demonstrate how to handle edge cases, etc. Using such techniques, for example, the system may learn that boxes are not necessarily stiff or incompressible. Instead, in some cases, the system may be able to apply slightly greater force to enable a box or other item to be squeezed in between other items. Or, an item may be worked into an end position, adjacent to a truck or container wall, by first inserting a corner and then rotating the box and pushing it into position.

In some embodiments, prior to being used in training a trajectory navigated by a human may be captured as a time series of data. The series may be modified, as described above, e.g., by deleting points or segments that offset each other, and/or the trajectory may be “sped up”, since the system may be able to safely move the robot more quickly through the points comprising the trajectory than the human did.

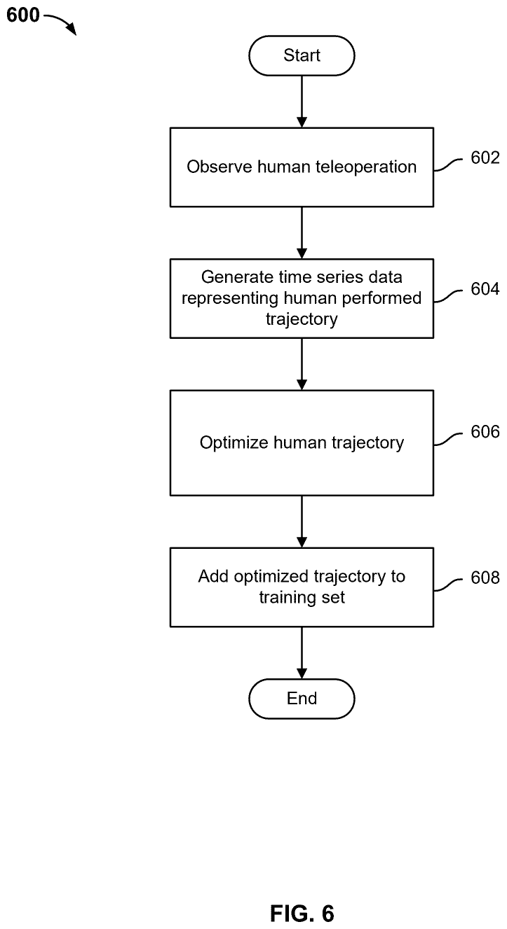

FIG. 6 is a flow diagram illustrating an embodiment of a process to augment a set of training data to train an artificial intelligence (AI) based robotic manipulation system. In various embodiments, process 600 of FIG. 6 may be performed by a control computer, such as control computer 110, or another computer, operating or preparing to operate in a training mode of operation, e.g., as in the example described above in connection with FIG. 3.

In the example shown in FIG. 6, at 602 the system observes a human while using a robotic arm or other robot in a teleoperation mode of operation, in which the human uses a manual controller or other physical interface to provide inputs to control operation of the robot to perform a task, such as picking, moving, and placing a sequence of items. One or more of the inputs, the lower-level robotic control commands to which they are mapped, and the resulting trajectory may be observed, for example. At 604, time series data representing the human-performed trajectory is generated. For example, the observed trajectory may be represented as a time series each element of which is associated with a timestamp, position, orientation, velocity vector and/or other trajectory data.

At 606, the human trajectory is made more optimal. For example, the human operator may have moved to robot and the item in its grasp slowly through the workspace, but at 606 the system performing process 600 may speed it up. Or the human may have taken long way around an obstacle or may simply have taken a less direct path than may have been optimal, and the at 606 the system may adjust the trajectory to make the path more direct.

At 608, the optimized trajectory is added to a training data set. For example, a set of observation data representing a starting state and objective (task) may be stored and associated with the optimized trajectory generated at 606. In training, the observations may be provided as input and the corresponding output compared with the optimized trajectory, as in the training described above with reference to FIG. 3.

In some embodiments, random data, e.g., “noise”, may be added to trajectories generated by a model and the resulting trajectory is evaluated, e.g., via simulation, attempting to implement the trajectory in real life, etc. If the result is better than for other trajectories, the system may learn to generate better trajectories in the future. In various embodiments, the system uses randomness to improve its model via reinforcement learning, which may enable the system to discover possibilities it has seen previously.

In various embodiments, once a first level of training has been performed as described above, additional information may be added. For example, cameras in the workspace or mounted on the robot may be used to generate a view of the workspace, including the robot, items in the workspace, a box or other item in the robot's grasp, etc. For example, the training described above could be based on configuration data representing the physical dimensions and layout of the workspace and force/touch may be used to grasp, move, and place items. Adding computer vision as an additional input (i.e., an additional generative AI “head” feeding into the AI transformer) enables dynamic conditions, such as a human walking into or through the workspace, a box sagging so that its bottom is lower than expected, a box has been dropped or fallen of a pallet, etc., to be taken into consideration. Initially, the system will not know how to make sense of the additional input, but over time the system will learn to use the information to its advantage, e.g., via a continuation of the learning process as described above, but with the additional input being taken into consideration.

In various embodiments, data generated as described above may be augmented to increase the training data set. For example, a trajectory may be simulated more than once with different properties, e.g., with different dimensions, materials, compressibility, etc. of a box the placement of which is being simulated. Similarly, control gains (e.g., stiffness versus compliance), friction, and other physics properties may be modified, and the trajectory simulation runs again, each simulation producing a corresponding time series of data from which the system can learn. For example, the system may learn it can safely overcome a higher degree of friction, e.g., by pushing with higher force, without damaging the item in its grasp. Without such learning, the system might encounter higher friction than it has seen previously and mistake the force feedback from the high friction as a collision.

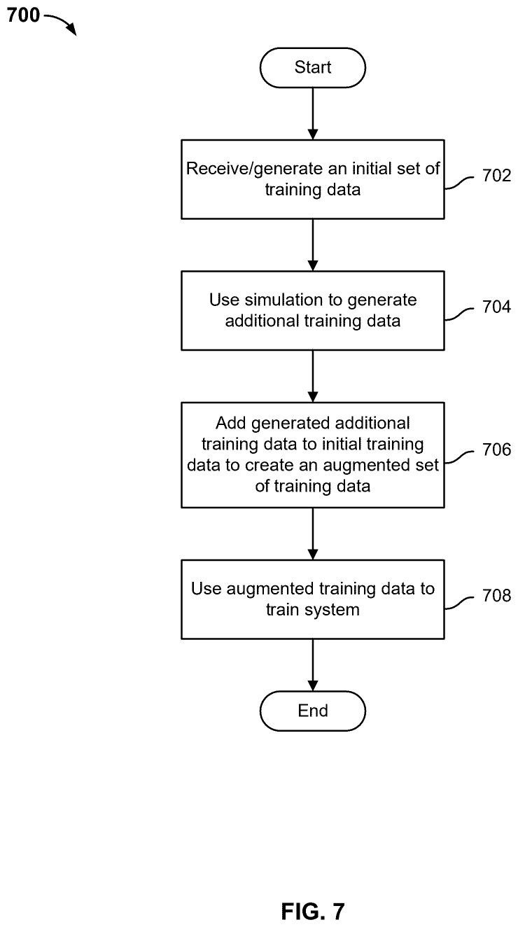

FIG. 7 is a flow diagram illustrating an embodiment of a process to augment a set of training data to train an artificial intelligence (AI) based robotic manipulation system. In various embodiments, process 700 of FIG. 7 may be performed by a control computer, such as control computer 110, or another computer, operating or preparing to operate in a training mode of operation, e.g., as in the example described above in connection with FIG. 3.

In the example shown in FIG. 7, at 702 an initial set of training data is received. Each element of the set may include a set of observations representing an initial state and objective (task) and a corresponding reference trajectory to which trajectories generated during training based on the observations can be compared. At 704, simulation is used to generate additional training data. For example, parameters for an element of the initial training data received at 702 (e.g., item size, attributes, location, orientation, destination; location, size, and attributes of an obstacle; etc.) may be varied and simulation used to determine a corresponding trajectory. At 706, a set of observations corresponding to the original observations as modified and a corresponding trajectory determined via simulation are added to the training data as an additional element. At 708, the augmented training data is used to train the system.

In various embodiments, techniques disclosed herein may be used to provide a generative AI-based robotic control system that provides trajectories and corresponding robotic commands to implement them, quickly and without human intervention.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a communication interface; and
a processor coupled to the communication interface and configured to:
receive via the communication interface a set of observations associated with a context in which a robotic manipulator is operating and an objective the robotic manipulator is configured to be used to achieve;
generate a vector representation of the observations;
apply one or more layers of transformer to the vector to generate an output vector;
use the output vector to generate a set of robot control commands for the robotic manipulator; and
send the set of robot control commands to the robotic manipulator;
wherein the robotic manipulator is configured to perform in response to the set of robot control commands one or more actions associated with achieving the objective.

2. The robotic system of claim 1, wherein the output vector is mapped to a set of velocity vectors and the robotic manipulator is configured to respond to the set of robot control commands by moving through a trajectory as indicated by the set of velocity vectors.

3. The robotic system of claim 1, wherein the robotic manipulator comprises a robotic arm.

4. The robotic system of claim 1, wherein the objective comprises moving an item from an initial location to a destination location.

5. The robotic system of claim 1, wherein the one or more layers of transformers comprise a multilevel neural network.

6. The robotic system of claim 5, wherein at each layer an associated set of transformation functions is applied to an input vector received at that layer, from an encoder in the case of the first layer and from a preceding layer in subsequent layers, to produce a transformed vector as output of that layer.

7. The robotic system of claim 1, wherein the set of observations includes image data of a workspace comprising the context in which a robotic manipulator is operating.

8. The robotic system of claim 1, wherein the set of observations includes an estimated state of a workspace comprising the context in which a robotic manipulator is operating.

9. The robotic system of claim 1, wherein the set of observations includes one or more of a current position, velocity, and pose of the robotic manipulator.

10. The robotic system of claim 1, wherein the set of observations includes a set of forces and torques associated with the robotic manipulator contacting an obstacle or object in a workspace comprising the context in which a robotic manipulator is operating.

11. The robotic system of claim 1, wherein the set of observations comprises a first set of observations and the set of robot control commands comprises a first set of robot control commands and wherein the processor is further configured to receive via the communication interface a second set of observations associated with the context in which a robotic manipulator is operating, subsequent to sending the first set of robot control commands to the robotic manipulator, and use the second set of observations to generate a second set of robot control commands for the robotic manipulator.

12. The robotic system of claim 11, wherein the second set of observations reflects a change in the context in which a robotic manipulator is operating.

13. The robotic system of claim 11, wherein the second set of observations reflects a human moving into or through a workspace comprising the context in which a robotic manipulator is operating.

14. The robotic system of claim 1, wherein the one or more layers of transformer are trained to generate the output vector usable to generate the set of robot control commands for the robotic manipulator to achieve the objective at least in part by using a training set comprising a plurality of training sets of observation data and corresponding objectives and for each set of observation data a corresponding set of robot control commands known to be effective to accomplish the corresponding objective, and for each set of training data iteratively running the observations through the one or more layers of transformer to generate a training set of robot control commands, comparing the training set of robot control commands to the corresponding set of robot control commands known to be effective to accomplish the corresponding objective, and adjusting one or more parameters of the one or more layers of transformer based at least in part on the comparison.

15. The robotic system of claim 14, wherein the training includes repeating said iteratively running the observations through the one or more layers of transformer until the comparison indicates the one or more layers of transformer have produced a final training set of robot control commands that satisfy a success criteria associated with the corresponding set of robot control commands known to be effective to accomplish the corresponding objective.

16. The robotic system of claim 14, wherein the training data set is augmented by creating an additional training set by varying one or more parameters in an existing training set and corresponding objective included in the plurality of training sets of observation data and corresponding objectives.

17. The robotic system of claim 16, wherein the one or more parameters are varied at least in part by applying a robot control heuristic.

18. The robotic system of claim 16, wherein existing training set is associated with a session of human teleoperation of the robotic manipulator and the one or more parameters are varied by one or more of increasing a speed of a trajectory and modify the path of the trajectory.

19. The robotic system of claim 1, wherein the processor is configured to use the output vector to generate the set of robot control commands for the robotic manipulator at least in part by mapping the output vector at an initial trajectory and modifying the initial trajectory to produce an optimized trajectory.

20. The robotic system of claim 19, wherein the optimized trajectory is produced at least in part by eliminating one or more segments or points from the initial trajectory.

21. A method of robotic control, comprising:
receiving via a communication interface a set of observations associated with a context in which a robotic manipulator is operating and an objective the robotic manipulator is configured to be used to achieve;
using a processor to:
generate a vector representation of the observations;
apply one or more layers of transformer to the vector to generate an output vector;
use the output vector to generate a set of robot control commands for the robotic manipulator; and
send the set of robot control commands to the robotic manipulator;
wherein the robotic manipulator is configured to perform in response to the set of robot control commands one or more actions associated with achieving the objective.

22. A computer program product embodied in a non-transitory computer readable medium and comprising computer instructions for:
receiving via a communication interface a set of observations associated with a context in which a robotic manipulator is operating and an objective the robotic manipulator is configured to be used to achieve;
generating a vector representation of the observations;
applying one or more layers of transformer to the vector to generate an output vector;
using the output vector to generate a set of robot control commands for the robotic manipulator; and
sending the set of robot control commands to the robotic manipulator;
wherein the robotic manipulator is configured to perform in response to the set of robot control commands one or more actions associated with achieving the objective.
